(19) United States
(12) Patent Application Publication
(10) Pub. No.: US 2014/0143647 A1
(43) Pub. Date: May 22, 2014

(54) METHOD FOR IMPROVING BROWSER CACHE BY REDUCING DUPLICATE STORED CONTENT

(71) Applicant: QUALCOMM INCORPORATED, San Diego, CA (US)

(72) Inventors: Mohammad H. Reshadi, Sunnyvale, CA (US); Vrajesh R. Bhavsar, Sunnyvale, CA (US)

(73) Assignee: QUALCOMM INCORPORATED, San Diego, CA (US)

(21) Appl. No.: 13/678,882

(22) Filed: Nov. 16, 2012

(51) Int. Cl. G06F 17/00

(52) U.S. Cl. 715/234

(57) ABSTRACT

Methods, systems and devices for utilizing signatures to avoid storing redundant webpage resources within a browser cache. In an aspect, a mobile device may receive a resource when generating a webpage hosted by a web server. The mobile device may generate a signature that represents the content of the resource. The mobile device may also compare the generated signature to a list of other signatures related to resources currently stored within the browser cache. When the generated signature does not match one of the other signatures, the mobile device may add the signature to the list and store the resource within the browser cache. In an aspect, the signature may be obtained from the web server or another computing device, and when the obtained signature is not within the list of other signatures, the mobile device may download the resource for storage in the browser cache.

### BACKGROUND

Webpages utilize many resources that a computing device executing a browser application needs to download from web servers before processing and rendering the webpage contents. As computation ability and storage capacity have improved at a faster rate than network latency and bandwidth, browser applications often cache downloaded content for reuse in subsequent visits to webpages and employ eviction policies (or algorithms) to remove old content and make room for new content. When a resource of a webpage is requested by a browser application, caching techniques typically compare the universal resource identifier (or URI) of the resource to URI's of resources already available in a browser cache. However, even when the requested resource's URI is already available, the browser application may still make a request to the webpage's web server to confirm it can reuse the cached resource. For example, the browser application may communicate with the web server to determine whether the cached resource is up-to-date or otherwise valid. Accordingly, there may be round trip communication latency due to the multiple communications between the browser application and web server.

Many current trends in browser application technology can further reduce the effectiveness of caching. With increased mobility and connectivity, mobile device users tend to visit many websites with increased periodicity (e.g., hourly, daily, weekly, etc.), and as a result, must typically re-download resources due to cache eviction policies in mobile devices necessitated by their limited memory. Webpages and web apps are also becoming increasingly complex, often referencing greater amounts of content (e.g., cascading style sheets, images, multi-media, scripts, etc.) that provide richer interactive experiences but also increase the probability of evicting other content from the browser cache. Additionally, to guarantee compatibility, many webpages and applications copy identical resources onto their respective web servers. For example, many webpages utilize the same popular frameworks (e.g., jQuery), themes, and/or styles. As a result, the browser cache may include redundant (or duplicate) framework resources that can be large in size. Further, webpages may use only slightly different or customized versions of the same library, framework, and/or utility, resulting in many different URI's for similar resources within the browser cache. The above trends may also negatively impact other techniques that might rely on the browser cache (e.g., pre-processing cache content and crowd sourcing cache behavior).

### SUMMARY

The various aspects include methods for avoiding storage of redundant webpage content in a browser cache that may include comparing a first signature based on contents of a first resource referenced by a webpage to a group of signatures related to resources stored in the browser cache, using a second resource stored in the browser cache to generate the webpage when the first signature matches one of the group of signatures but not storing the first resource in the browser cache, and storing the first resource in the browser cache linked to the first signature and adding the first signature to the group of signatures when the first signature does not match any signature within the group of signatures. In a further aspect, the methods may also include evicting a third resource stored in the browser cache when the first signature does not match any signature within the group of signatures based on a cache eviction policy, and removing a third signature corresponding to the third resource from the group of signatures in response to evicting the third resource. In a further aspect, the first resource may be associated with a universal resource identifier. In a further aspect, the first resource may be a file of a cacheable content type. In a further aspect, the first resource may be at least one of a style sheet, a framework, an application programming interface, a library file, a video, an image, a photo, a text file, a Flash file, a Shockwave file, an applet, software instructions, a script, and a theme. In a further aspect, comparing a first signature based on contents of a first resource referenced by a webpage to a group of signatures related to resources stored in the browser cache may include downloading the first resource based on instructions for rendering the webpage, generating the first signature based on contents of the first resource, and comparing the generated first signature to the group of signatures related to resources currently stored within the browser cache. In a further aspect, comparing a first signature based on contents of a first resource referenced by a webpage to a group of signatures related to resources stored in the browser cache may include obtaining the first signature for the first resource when initially downloading the webpage, comparing the obtained first signature to the group of signatures related to resources stored in the browser cache, using the second resource stored in the browser cache to generate the webpage when the obtained first signature matches one of the group of signatures related to resources stored in the browser cache, downloading the first resource, and using the downloaded first resource to generate the webpage when the obtained first signature does not match any of the group of signatures related to resources stored in the browser cache. In a further aspect, the obtained first signature may be obtained from a third-party service, a proxy server, and/or a web server hosting the webpage. In a further aspect, the obtained first signature may be generated by a third-party service, a proxy server, and/or a web server hosting the webpage.

An aspect mobile device may include means for comparing a first signature based on contents of a first resource referenced by a webpage to a group of signatures related to resources stored in the browser cache, means for using a second resource stored in the browser cache to generate the webpage when the first signature matches one of the group of signatures but not storing the first resource in the browser cache, and means for storing the first resource in the browser cache linked to the first signature and adding the first signature to the group of signatures when the first signature does not match any signature within the group of signatures. In a further aspect, the mobile device may also include means for evicting a third resource stored in the browser cache when the first signature does not match any signature within the group of signatures based on a cache eviction policy, and means for removing a third signature corresponding to the third resource from the group of signatures in response to evicting the third resource. In a further aspect, the first resource may be associated with a universal resource identifier. In a further aspect, the first resource may be a file of a cacheable content type. In a further aspect, the first resource may be at least one of a style sheet, a framework, an application programming interface, a library file, a video, an image, a text file, a photo, a Flash file, a Shockwave file, an applet, software instructions, a script, and a theme. In a further aspect, the means for comparing a first signature based on contents of a first resource referenced by a webpage to a group of signatures related to resources stored in the browser cache may include means for downloading the first resource based on instructions for rendering the webpage, means for generating the first signature based on contents of the first resource, and means for comparing the generated first signature to the group of signatures related to resources currently stored within the browser cache. In a further aspect, the means for comparing a first signature based on contents of a first resource referenced by a webpage to a group of signatures related to resources stored in the browser cache may include means for obtaining the first signature for the first resource when initially downloading the webpage, means for comparing the obtained first signature to the group of signatures related to resources stored in the browser cache, means for using the second resource stored in the browser cache to generate the webpage when the obtained first signature matches one of the group of signatures related to resources stored in the browser cache, means for downloading the first resource, and means for using the downloaded first resource to generate the webpage when the obtained first signature does not match any of the group of signatures related to resources stored in the browser cache. In a further aspect, the obtained first signature may be obtained from a third-party service, a proxy server, and/or a web server hosting the webpage. In a further aspect, the obtained first signature may be generated by a third-party service, a proxy server, and/or a web server hosting the webpage.

An aspect mobile device may include a memory, a transceiver configured to communicate with a network, and a processor coupled to the memory and the transceiver, and the processor may be configured with processor-executable instructions to perform operations that may include comparing a first signature based on contents of a first resource referenced by a webpage to a group of signatures related to resources stored in the browser cache, using a second resource stored in the browser cache to generate the webpage when the first signature matches one of the group of signatures but not storing the first resource in the browser cache, and storing the first resource in the browser cache linked to the first signature and adding the first signature to the group of signatures when the first signature does not match any signature within the group of signatures. In a further aspect, the processor may be configured with processor-executable instructions to perform operations that further include evicting a third resource stored in the browser cache when the first signature does not match any signature within the group of signatures based on a cache eviction policy, and removing a third signature corresponding to the third resource from the group of signatures in response to evicting the third resource. In a further aspect, the processor may be configured with processor-executable instructions to perform operations such that the first resource may be associated with a universal resource identifier. In a further aspect, the processor may be configured with processor-executable instructions to perform operations such that the first resource may be a file of a cacheable content type. In a further aspect, the processor may be configured with processor-executable instructions to perform operations such that the first resource may be at least one of a style sheet, a framework, an application programming interface, a library file, a video, an image, a photo, a Flash file, a Shockwave file, an applet, software instructions, a script, and a theme. In a further aspect, the processor may be configured with processor-executable instructions to perform operations such that comparing a first signature based on contents of a first resource referenced by a webpage to a group of signatures related to resources stored in the browser cache may include downloading the first resource based on instructions for rendering the webpage, generating the first signature based on contents of the first resource, and comparing the generated first signature to the group of signatures related to resources currently stored within the browser cache. In a further aspect, the processor may be configured with processor-executable instructions to perform operations such that comparing a first signature based on contents of a first resource referenced by a webpage to a group of signatures related to resources stored in the browser cache may include obtaining the first signature for the first resource when initially downloading the webpage, comparing the obtained first signature to the group of signatures related to resources stored in the browser cache, using the second resource stored in the browser cache to generate the webpage when the obtained first signature matches one of the group of signatures related to resources stored in the browser cache, downloading the first resource, and using the downloaded first resource to generate the webpage when the obtained first signature does not match any of the group of signatures related to resources stored in the browser cache. In a further aspect, the processor may be configured with processor-executable instructions to perform operations such that the obtained first signature may be obtained from a third-party service, a proxy server, and/or a web server hosting the webpage. In a further aspect, the processor may be configured with processor-executable instructions to perform operations such that the obtained first signature may be generated by a third-party service, a proxy server, and/or a web server hosting the webpage.

An aspect non-transitory processor-readable storage medium having stored thereon processor-executable software instructions configured to cause a processor to perform operations for avoiding storage of redundant webpage content in a browser cache may include operations that include comparing a first signature based on contents of a first resource referenced by a webpage to a group of signatures related to resources stored in the browser cache, using a second resource stored in the browser cache to generate the webpage when the first signature matches one of the group of signatures but not storing the first resource in the browser cache, and storing the first resource in the browser cache linked to the first signature and adding the first signature to the group of signatures when the first signature does not match any signature within the group of signatures. In a further aspect, the stored processor-executable software instructions may be configured to cause a processor to perform operations that may further include evicting a third resource stored in the browser cache when the first signature does not match any signature within the group of signatures based on a cache eviction policy, and removing a third signature corresponding to the third resource from the group of signatures in response to evicting the third resource. In a further aspect, the stored processor-executable software instructions may be configured to cause a processor to perform operations such that the first resource may be associated with a universal resource identifier. In a further aspect, the stored processor-executable software instructions may be configured to cause a processor to perform operations such that the first resource may be a file of a cacheable content type. In a further aspect, the stored processor-executable software instructions may be configured to cause a processor to perform operations such that the first resource may be at least one of a style sheet, a framework, an application programming interface, a library file, a video, an image, a photo, a Flash file, a Shockwave file, an applet, software instructions, a script, and a theme. In a further aspect, the stored processor-executable software instructions may be configured to cause a processor to perform operations such that comparing a first signature based on contents of a first resource referenced by a webpage to a group of signatures related to resources stored in the browser cache may include downloading the first resource based on instructions for rendering the webpage, generating the first signature based on contents of the first resource, and comparing the generated first signature to the group of signatures related to resources currently stored within the browser cache. In a further aspect, the stored processor-executable software instructions may be configured to cause a processor to perform operations such that comparing a first signature based on contents of a first resource referenced by a webpage to a group of signatures related to resources stored in the browser cache may include obtaining the first signature for the first resource when initially downloading the webpage, comparing the obtained first signature to the group of signatures related to resources stored in the browser cache, using the second resource stored in the browser cache to generate the webpage when the obtained first signature matches one of the group of signatures related to resources stored in the browser cache, downloading the first resource, and using the downloaded first resource to generate the webpage when the obtained first signature does not match any of the group of signatures related to resources stored in the browser cache. In a further aspect, the stored processor-executable software instructions may be configured to cause a processor to perform operations such that the obtained first signature may be obtained from a third-party service, a proxy server, and/or a web server hosting the webpage. In a further aspect, the stored processor-executable software instructions may be configured to cause a processor to perform operations such that the obtained first signature may be generated by a third-party service, a proxy server, and/or a web server hosting the webpage.

An aspect system may include a server and a mobile device, with the server configured with server-executable instructions to perform operations that may include generating a first signature based on contents of a first resource associated with a webpage, receiving a request corresponding to the webpage from the mobile device, transmitting instructions for rendering the webpage to the mobile device in response to receiving the request, wherein the instructions include the first signature. In the aspect system the mobile device may include a memory, a transceiver configured to communicate with a network coupled to the server, and a processor coupled to the memory and the transceiver, and configured with processor-executable instructions to perform operations that may include transmitting the request corresponding to the webpage to the server, receiving instructions for rendering the webpage from the server, obtaining the first signature from the received instructions, comparing the first signature to a group of signatures related to resources stored in a browser cache of the mobile device, using a second resource stored in the browser cache to generate the webpage when the first signature matches one of the group of signatures but not storing the first resource in the browser cache, and storing the first resource in the browser cache linked to the first signature and adding the first signature to the group of signatures when the first signature does not match any signature within the group of signatures. In a further aspect, the server may be one of a third-party service server, a proxy server, and a web server hosting the webpage.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIG. 1 is a communication system block diagram illustrating a communication system suitable for use in various aspects.

FIG. 2 is a diagram of a webpage referencing various resources to be downloaded by a mobile device into a browser cache.

FIG. 3 is a diagram of three webpages referencing a similar resource to be downloaded by a mobile device into a browser cache.

FIG. 4 is a diagram of two different webpages referencing various resources to be downloaded by a mobile device into a browser cache.

FIG. 5 is a diagram of two different webpages referencing various resources to be downloaded by a mobile device and associated with signatures.

FIG. 6 is a process flow diagram illustrating an aspect method for a mobile device generating signatures for webpage resources.

FIG. 7 is a process flow diagram illustrating an aspect method for a mobile device using signatures received from a third-party (e.g., the webpage hosting server) to avoid storing redundant copies of a resource for a webpage in a browser cache.

FIG. 8 is a component block diagram of a notebook computing device suitable for use with the various aspects.

FIG. 9 is a component block diagram of a mobile device suitable for use in an aspect.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The term “resource” is used herein to refer to any file (e.g., text, image, data, script, etc.) or asset associated with a webpage that may be indicated, represented, or referenced by a universal resource identifier (URI). Further, a resource may be capable of being downloaded, stored, accessed, cached, and/or otherwise used by mobile devices. Resources may include files or assets of any cacheable content type. Examples of resources may include style sheets (e.g., cascading style sheets or “CSS”), frameworks (e.g., utility suites, etc.), application programming interfaces (API), library files (e.g., dynamically loaded libraries (DLL), etc.), media files (e.g., videos, images, photos, Flash files, Shockwave files, etc.), applets, software instructions, scripts, and themes.

The various aspects provide methods for increasing mobile device efficiency by using signatures to avoid storing duplicate webpage resources in a browser cache. For each universal resource identifier (URI) of webpages to be rendered, the mobile device may perform operations to assess, categorize, define, and otherwise identify the characteristics and content of the corresponding webpage resource. For example, the mobile device may identify an image file associated with a certain URI based on the values and arrangement of bits and/or header information within the file. The mobile device may store a resource in the cache when that resource's contents are not currently stored. Further, when different webpages reference different URIs for rendering a particular resource content already stored within the browser cache, the mobile device may use the same cached content to render the different URIs and also may avoid evicting resources to make room for redundant resources.

The mobile device may generate a signature that represents the resource's content. For example, the mobile device may perform an algorithm on the resource to generate signature data that uniquely describes the resource's contents. In an aspect, the mobile device may perform a hash operation, a message-digest algorithm (e.g., “md5”), and/or a similar algorithm to generate the resource's signature. The operations, algorithms, and/or routines used to generate the signature may be standardized and known to other computing devices such that given a same resource, numerous devices may generate identical signatures. In another aspect, the mobile device may evaluate the contents of the resource by using heuristics to identify similar resources and generate a signature.

The mobile device may maintain a data table that stores signatures for all web page resources stored within the browser cache. The signature data table may also store URI's and browser cache memory locations associated with signatures. When the generated signature related to the URI is within the signature data table (i.e., identical resource contents have been previously downloaded and is stored in the cache), the mobile device may avoid storing the resource in the browser cache and also avoid executing a cache eviction routine. As the browser cache may contain resources corresponding to a plurality of webpages, the signature data table may contain signature entries that correspond to resources that may be found in one or more different webpages. For example, a signature entry may represent that a particular resource is stored in the browser cache and may be used to render two different webpages.

In various aspects, the mobile device may generate signatures of downloaded resources within the browser cache during idle periods. For example, signatures may not be generated at the time of download and storage of resources in cache, but instead when the browser application is closed. Alternatively, signatures may be generated on lower-priority processes (e.g., operating system threads) concurrently with the execution of browser application and/or caching operations.

In another aspect, the mobile device may avoid downloading an already present webpage object by obtaining (or receiving) signature information regarding webpage resources from third-party devices, such as a web server providing the webpage resource or a third-party server. For example, for a large framework or utility file referenced by the webpage (e.g., jQuery libraries), the webpage's web server may generate and transmit a signature for the file when the webpage is initially requested by the mobile device. In various aspects, signatures may be included in the resource's URI, such as URI and signature pairs added to the header of the webpage's HTML code, or in separate exchanges from the web server in response to special signature requests from a browser application. In another aspect, the signature information may be provided by an intermediate proxy server and/or a third-party service that may receive webpage requests from the mobile device, along with the signature information of the current browser cache resources, and return webpage resources and updated signature information to the mobile device. For example, in response to receiving a message from the mobile device indicating the current signatures represented in the mobile device's signature data table, a third-party server may transmit a return message to the mobile device that indicates the resources of a webpage that the mobile device does not currently posses within its browser cache.

In an aspect, the mobile device may use code management techniques, such as employed in “versioning” software (e.g., “Git”), to detect and store differences in objects or resources that are substantially similar. In particular, for frameworks and libraries, such as jQuery, different webpages may utilize different versions of the same resource that differ only slightly. For example, two versions of a jQuery library may differ by a single utility function. Rather than store two full copies of the resource in the browser cache, the mobile device may determine the differences (i.e., deltas) between similar resources and compose different versions of the resources on the fly. For example, the mobile device may store the content of one resource and the delta of a similar resource.

The various aspects facilitate the efficient operation of mobile devices in a number of ways. In particular, the various aspects may enable mobile devices to conserver battery power by avoiding unnecessary computing and/or downloading of webpage resources. For example, a mobile device performing aspect methods may determine that a resource that is indicated by a URI is already stored within the mobile device's browser cache, and in response, avoid expending the battery power that would otherwise be required to download the resource using a cellular network modem and/or antenna. Further, the various aspects may improve the user experience by enabling faster rendering of webpages, extending the time that the mobile device operates on a battery charge, and reducing the amount of data communicated over the wireless network, which can save the user money and make better use of limited cellular network data plans.

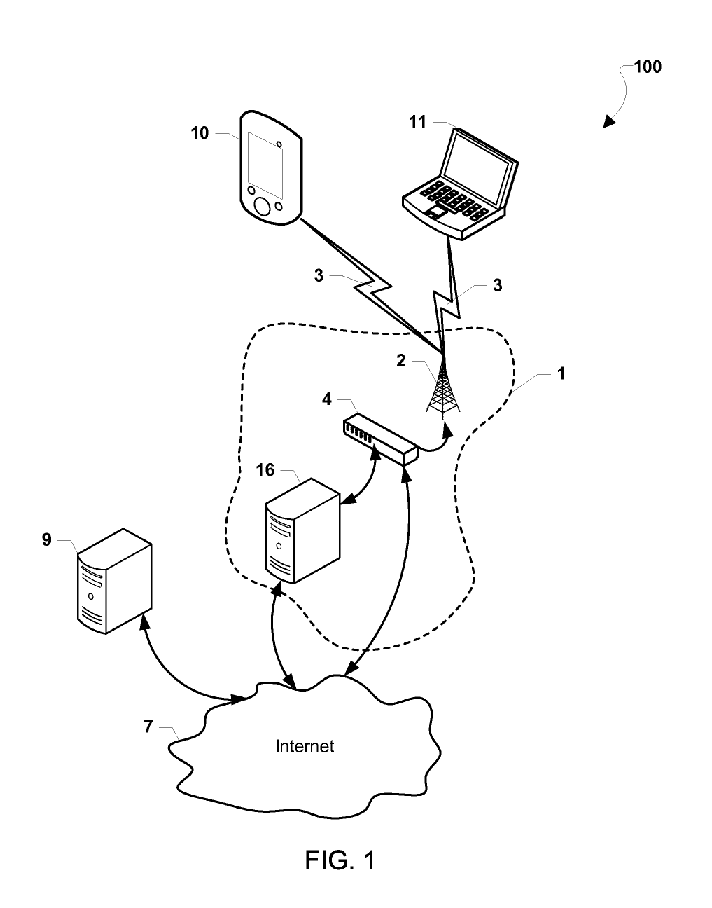

The various aspects may be implemented within a variety of wireless or mobile communications systems, an example of which is illustrated in FIG. 1. The example communication system 100 illustrated in FIG. 1 includes a wide area network 1, such as a cellular telephone network. A typical cellular telephone network includes a cellular base station 2 coupled to a network operations center 4, which operates to connect voice and data calls between mobile devices 10, 11 (e.g., mobile television receivers, laptop computers, smartphones, cellular phones, personal digital assistants, interactive game devices, notebooks, smartbooks, ultrabooks, or other such electronic devices) and other network destinations, such as via telephone land lines (e.g., a POTS network, not shown) and the Internet 7. Communications between mobile devices 10, 11 and the network 1 may be accomplished via two-way wireless communication links 3, such as 4G, 3G, CDMA, TDMA, and other cellular telephone communication technologies. To facilitate Internet data communications, the network 1 will typically include one or more servers 16 coupled to or within the network operations center 4 that provide a connection to the Internet 7. In various aspects, the mobile devices 10, 11 may alternatively connect to the Internet 7 via a wired or wireless local area network (not shown) through various connections (e.g., WiFi, Ethernet, etc.) and may receive content via well known conventional Internet access protocols.

A web server 9 may be connected to the Internet 7 and may receive requests for web content from the mobile devices 10, 11. For example, the mobile device 10 may generate a webpage download request that is transmitted to the web server 9 via the network 1 and the Internet 7. Upon receipt of such requests, the web server 9 may package and transmit web content to the mobile devices 10, 11. For example, the mobile devices 10, 11 may receive data representing HTML code, cascading style sheets (or “CSS”), and multimedia files (e.g., image files, video files, audio, etc.).

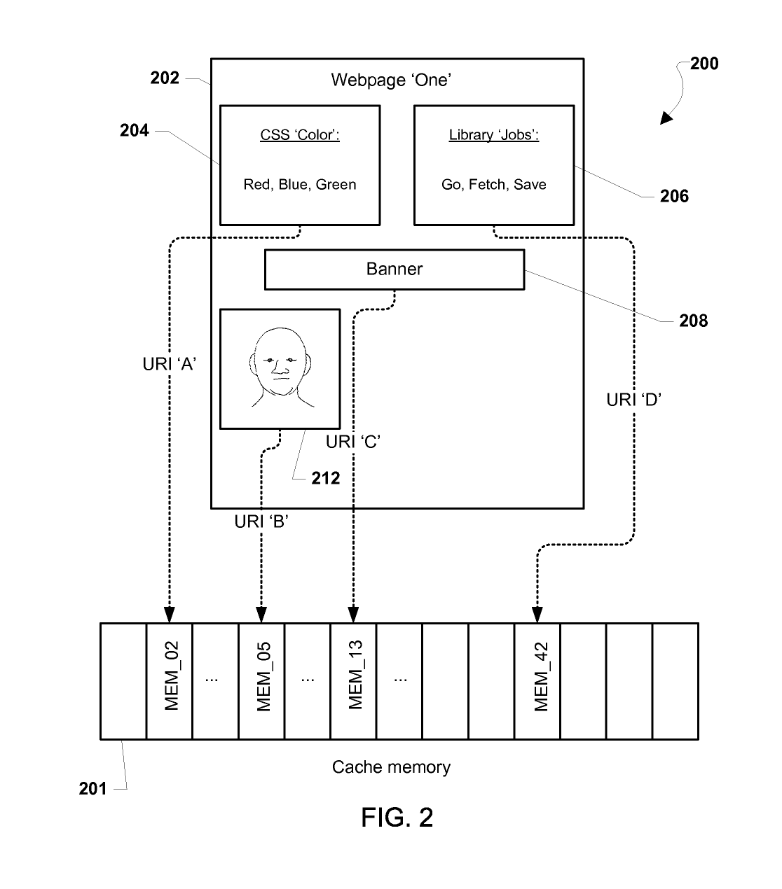

FIG. 2 is a diagram 200 of a webpage referencing various resources to be downloaded by a mobile device into a browser cache. In general, a mobile device, such as a smartphone, may execute software that requests, downloads, and renders content for a webpage. For example, a smartphone mobile device may execute a browser application that may transmit request messages to a web server via Internet communication protocols. Such software may receive instructions, such as HTML code, that define the webpage's layout, provide formatting (e.g., styles, fonts, positioning, etc.), and reference various resources of the webpage. The resources may each be defined in the instructions as URI information. For example, the HTML for the webpage may indicate the source and file path from which the software may download a particular image file for rendering the webpage. The mobile device may download resources based on the references within the instructions and may store the resources within different locations of the browser cache of the mobile device. In an aspect, the browser cache may be an area in a system cache allocated for use by a browser application and utilized for rendering webpages.

In particular, a webpage 202 (referred to in the diagram 200 as webpage ‘One’) may reference numerous resources, including a style sheet 204 (referred to in the diagram 200 as ‘Color’), a library object 206 (referred to in the diagram 200 as ‘Jobs’), a banner object 208 (e.g., an advertisement object or any other segment of content stored as a file on a web server), and an image file 212 (e.g., a .gif, .jpg, or any other image file type).

When the mobile device requests a download of the webpage 202, the mobile device may receive HTML or other instructions that reference the individual resources of the webpage 202. For example, the ‘Color’ style sheet 204 may correspond to a URI ‘A’, the ‘Jobs’ library object 206 may correspond to a URI ‘D’, the banner object 208 may correspond to a URI ‘C’, and the image file 212 may correspond to a URI ‘B’. Upon downloading each of the resources 204-212, the mobile device may store the resources 204-212 in different locations within the browser cache 201. For example, the mobile device may store the style sheet 204 in a memory location referred to as ‘MEM_{—}02’, the library object 206 in a memory location referred to as ‘MEM_{—}42’, the banner object 208 in a memory location referred to as ‘MEM_{—}13’, and the image file 212 in a memory location referred to as ‘MEM_{—}05’. In an aspect, the mobile device may utilize various algorithms for determining the locations of the browser cache 201 in which the resources 204-212 may be stored. For example, the mobile device may store the resources 204-212 in contiguous blocks or scattered throughout various locations of the browser cache 201.

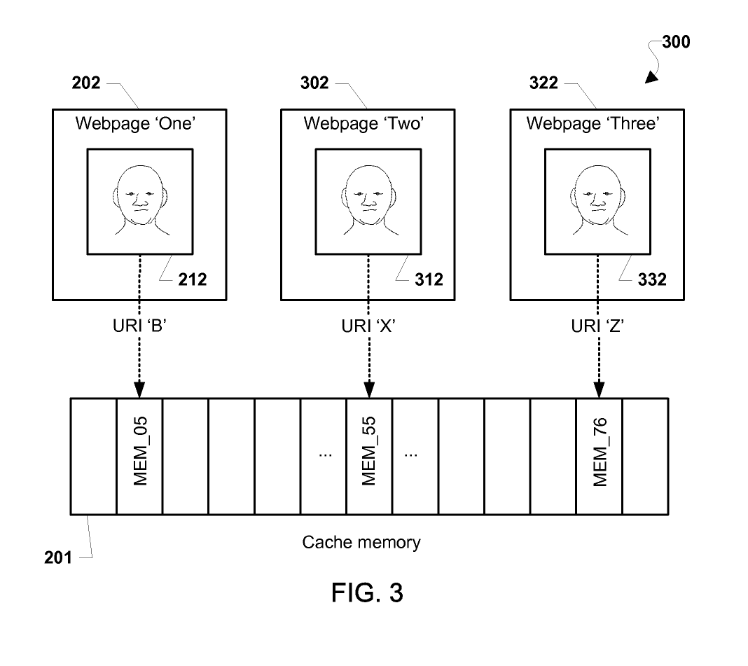

FIG. 3 is a diagram 300 of three webpages 202, 302, 322 referencing a similar resource to be downloaded by a mobile device into a browser cache 201. As the mobile device accesses different webpages, numerous resources from the individual webpages may be downloaded and stored in the browser cache 201. Dependent upon the browsing habits of the mobile device's user, cache eviction (or cache management) policies utilized by the mobile device, and the content of the various accessed webpages, the mobile device may store multiple copies of a similar or identical certain resource. For example, several different webpages may reference a photographic image file depicting a same, particular scene (e.g., a current events image released by the Associated Press and used by numerous news outlets).

As a non-limiting illustration, in a memory location referred to as ‘MEM_{—}05’, the mobile device may store a first image file 212 referenced by a first webpage 202 with URI ‘B’. In a memory location referred to as ‘MEM_{—}55’, the mobile device may store a second image file 312 referenced by a second webpage 302 with URI ‘X’. The second image file 312 may have the exact same content as the first image file 212 (e.g., the same imagery or depiction, the same binary information, etc.). In a memory location referred to as ‘MEM_{—}76’, the mobile device may store a third image file 332 referenced by a third webpage 322 with URI ‘Z’. The third image file 332 may have the exact same content as both the first image file 212 and the second image file 312.

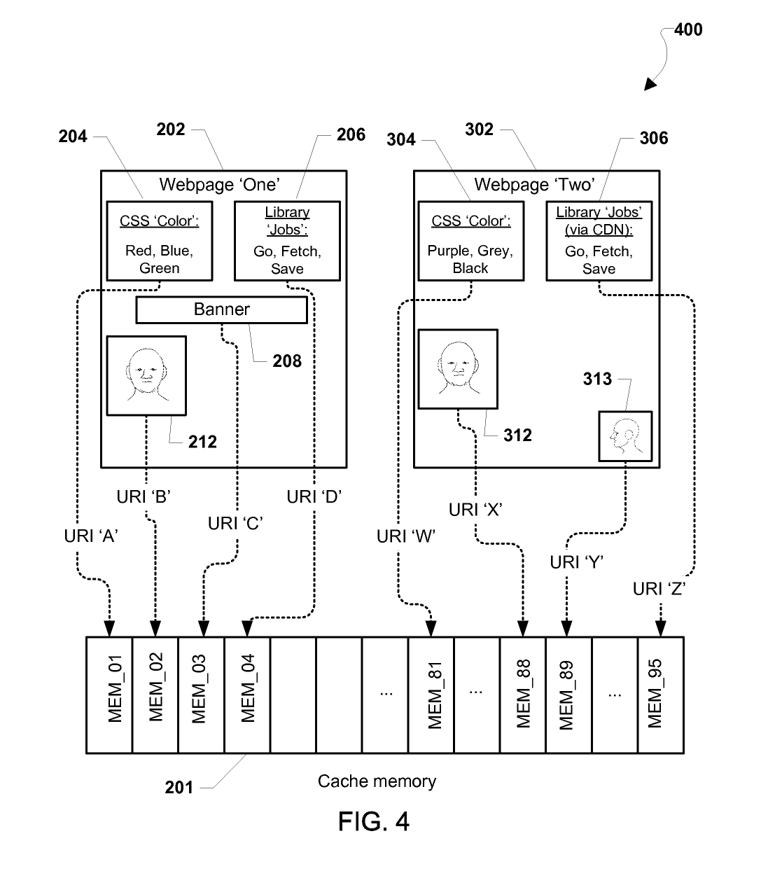

FIG. 4 is a diagram of two different webpages referencing various resources to be downloaded by a mobile device into a browser cache 201. Webpages may include unique resources not referenced by other webpages accessed by the mobile device. For example, a first webpage 202 (referred to in the diagram 400 as webpage ‘One’) may reference a banner object 208 with URI ‘C’, and a second webpage 302 (referred to in the diagram 400 as webpage ‘Two’) may reference an image file 313 with URI ‘Y’.

However, webpages may also include resources, such as frameworks and media files, that are similar to resources found on other webpages. For example, the first webpage 202 may reference an image file 212 with URI ‘B’, and the second webpage 302 may reference an identical image file 312 with URI ‘X’. Further, different webpages may reference identical content through different manners. In other words, a particular resource may exist as a discrete file on a web server or alternatively as a link to a file stored on an unrelated web server. For example, the first webpage 202 may reference a library object 206 (referred to in the diagram 400 as ‘Jobs’) with URI ‘D’. This library object 206 may be stored on the web server of the first webpage 202 and may include definitions to utilities named “Go,” “Fetch,” and “Save.” The second webpage 302 may also utilize an identical library object 306 (also referred to in the diagram 400 as ‘Jobs’) with URI ‘Z’. However, the second webpage 302 may utilize a content delivery network (or “CDN”) to distribute the library object 306. For example, the second webpage 302 may link to or otherwise utilize code or products from source delivery services, such as Microsoft or Google.

Numerous webpages may also use common resources to accomplish different results. For example, two different webpages may both utilize a common style sheet to define the formatting of the different resources and content of the webpages. However, the content of the resources may be modified for particular use in the webpages. In particular, common frameworks, utilities, style sheets applets, and library objects may be modified to suit the purposes of different webpages. In other words, different webpages may reference similar resources that may cause the mobile device to render the webpages' content in dissimilar ways or with varied functionality.

As a non-limiting illustration, the first webpage 202 may reference a style sheet 204 (referred to in the diagram 400 as CSS ‘Color’) with URI ‘A’. This style sheet 204 may be stored on the web server of the first webpage 202 and may include style definitions “Red,” “Blue,” and “Green” (e.g., “Red” may define width, height, and background color attributes for certain blocks of content). For example, the first webpage 202 may be rendered with the ‘Color’ style sheet 204 such that all text is colored red, blue or green. The second webpage 302 may also reference a style sheet 304 named ‘Color,’ however the style sheet 304 of the second webpage 302 may not define “Red,” “Blue,” or “Green” like in the first webpage 202. Instead, the second webpage's style sheet 304 may include style definitions “Purple,” “Grey,” and “Black.” For example, the second webpage 302 may be rendered with the ‘Color’ style sheet 304 such that all text is colored purple, grey, or black.

Regardless of the similarities or identical content within the various resources referenced by the two webpages 202, 302, the mobile device may store the resources in unique locations of the browser cache 201. For example, the second webpage's library object 306 may be stored in a separate location in the browser cache 201 (e.g., ‘MEM_{—}95’) despite containing the same utilities as the first webpage's library object 206 stored in the location in the browser cache 201 referred to as ‘MEM_{—}04’. Similar to as described above with reference to FIG. 3, the two identical image files 212, 312 may be also stored in separate locations in the browser cache 201 (i.e., ‘MEM_{—}02’ and ‘MEM_{—}88’).

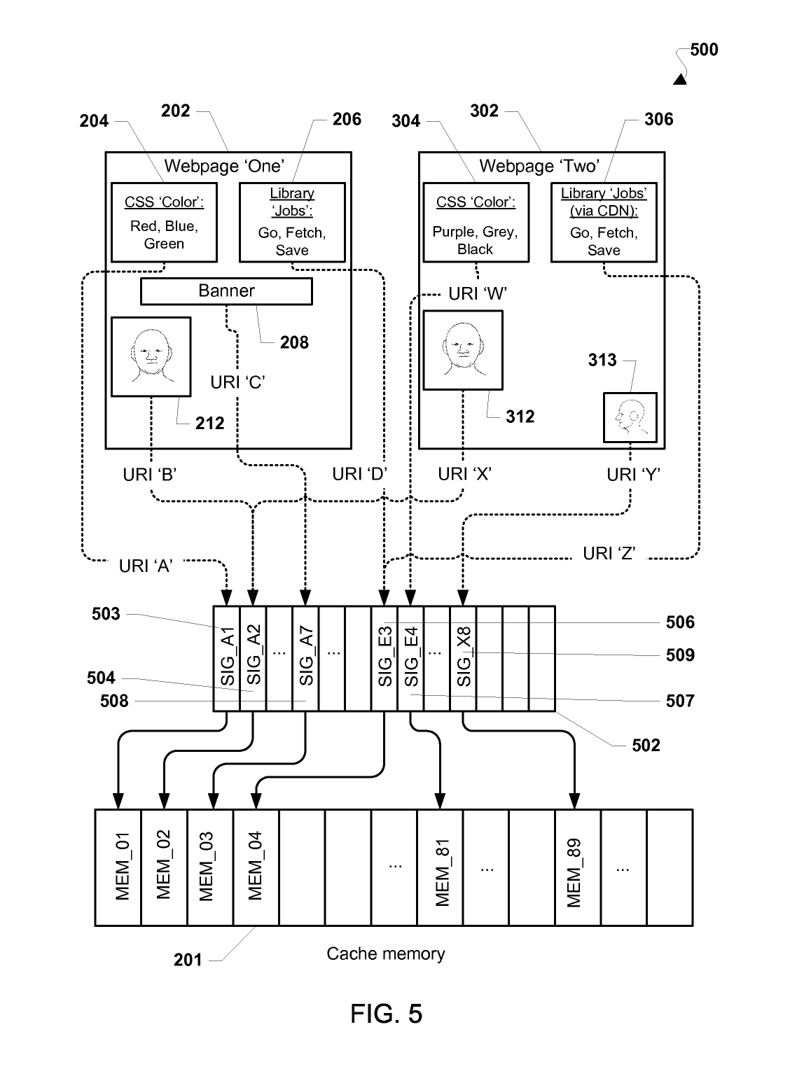

FIG. 5 illustrates a diagram 500 of two different webpages 202, 302 referencing various resources to be downloaded by a mobile device and associated with signatures. As described above, the mobile device may maintain a certain amount of resources within a browser cache 201 and may store redundant (or duplicate) resources provided by individual webpages. However, with signatures based on the content of such resources, the mobile device may avoid storing redundant copies of the resources.

In particular, a first webpage 202 (referred to in the diagram 500 as ‘One’) may reference numerous resources, including a style sheet 204 (referred to in the diagram 500 as ‘Color’), a library object 206 (referred to in the diagram 500 as ‘Jobs’), a banner object 208, and an image file 212. A second webpage 302 (referred to in the diagram 500 as ‘Two’) may also reference numerous resources, including a style sheet 304 (referred to in the diagram 500 as ‘Color’), a library object 306 (referred to in the diagram 500 as ‘Jobs’), a unique image file 313, and an image file 312 which may be identical to or a copy of the image file 212 referenced in the first webpage 202.

As described above, when the mobile device requests a download of the webpages 202, 302, the respective web servers receiving the requests may transmit HTML or other instructions that reference the various resources and indicate URI information for each individual resource. For example, the banner object 208 may correspond to a URI ‘C’, and the unique image file 313 may correspond to URI ‘Y’. Additionally, for resources having similar content or names, the webpages 202, 302 may still indicate separate URI's. For example, both webpages 202, 302 may reference style sheets 204, 304 referred to as ‘Color,’ but the style sheet 204 may correspond to URI ‘A’ whereas the style sheet 304 may correspond to URI ‘W’.

The mobile device may maintain a signature data table 502. In an aspect, the mobile device may maintain the signature data table 502 as a database within local memory that contains table entries for individual signatures that have been generated to represent the contents of various webpage resources. In other words, the signature data table 502 may have one signature entry for each unique resource. However, each signature entry in the signature data table 502 may contain references to multiple URI's for webpage resources including the signature content. For example, a signature entry within the signature data table 502 may include a plurality of URI's that correspond to resources having content consistent with a particular signature. Additionally, each signature entry may contain a reference to a single location in the browser cache 201 in which the mobile device stores the various webpage resource content (e.g., image files, libraries, etc.) corresponding to the signature.

For illustration, the first signature entry 503 (referred to in the diagram 500 as ‘SIG_A1’) may correspond to resource content defining the ‘Color’ style sheet 204 referenced with the URI ‘A’ of the first webpage 202. However, the similar ‘Color’ style sheet 304 of the second webpage 302 may be related to the different signature entry 507 (referred to in the diagram 500 as ‘SIG_E4’), as the two resources 204, 304 include different content. In particular, the style sheet 204 of the first webpage 202 includes “Red,” “Blue,” and “Green” items, and the style sheet 304 of the second webpage 302 includes “Purple,” “Grey,” and “Black” items. Additionally, the unique banner object 208 may correspond to a signature entry 508 (referred to in the diagram 500 as ‘SIG_A7’) and the unique image file 313 may correspond to a signature entry 509 (referred to in the diagram 500 as ‘SIG_X8’).

As additional illustration, the image files 212, 312 referenced by the webpages 202, 302 may include identical content (e.g., an identical picture), and thus both image files 212, 312 may correspond to the same signature entry 504 (referred to in the diagram 500 as ‘SIG_A2’) in the signature data table 502. Further, the library object 306 in the second webpage 302 may originate from a content delivery network, but may include the same “go,” “fetch,” and “save” functions as the library object 206 of the first webpage 202. Therefore, both library objects 206, 306 may correspond to a single signature entry 506 (referred to in the diagram 500 as ‘SIG_E3’). Thus, there may be multiple URL's or URI's associated with the same signature (or signature entry) that in turn references particular content stored in the cache 201.

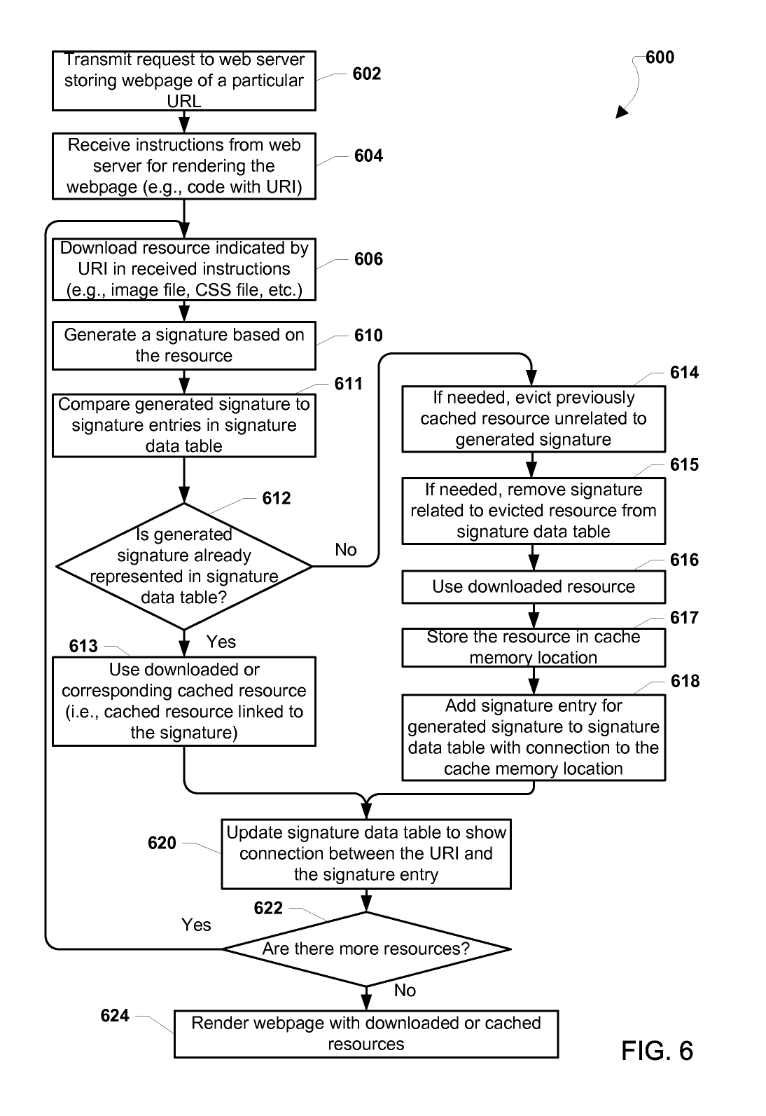

FIG. 6 illustrates an aspect method 600 for a mobile device utilizing signatures to manage webpage resources stored in a browser cache. In block 602, the mobile device may transmit a request to a web server storing a webpage of a particular URL, such as a message requesting delivery of the webpage. For example, the mobile device may execute a browser application that may exchange communications with the web server storing the webpage of the particular URL. In block 604, the mobile device may receive instructions from the web server for rendering the webpage. For example, in block 604 the mobile device may receive code that indicates the various URIs associated with the webpage. The instructions may be HTML code and may include header information, browser instructions for rendering the webpage's resources, and URI information for the various resources of the webpage. For example, the received instructions may indicate that an image file resource may be downloaded by the mobile device by using a certain URI.

In block 606, the mobile device may download a resource indicated by a URI in the received instructions from the web server. As noted above, such resources may be an image, video, text, library, or CSS file. In an aspect, the downloaded resource may be stored in temporary storage within the mobile device, such as a download buffer or other temporary use allocation within the browser cache. In block 610, the mobile device may generate a signature based on the resource. In various aspects, the mobile device may generate the signature using a standard algorithm, operation, and/or routine that creates representative data of the resource based on the resource contents, such as the binary electronic file. For example, the standard operations may be a commonly known hash algorithm. As described above, the generation of signatures may be standardized such that various computing devices and platforms may generate an identical signature based on the same resource. For example, the mobile device and a web server may generate identical signatures for a same image file using the standardized generation algorithms, operations, or routines.

In block 611, the mobile device may compare the generated signature to signature entries in a signature data table maintained by the mobile device. As described above, the signature data table may include entries for each unique signature corresponding to resources currently stored in browser cache locations. The mobile device may compare the generated signature to all signature entries in the signature data table to determine whether the resource contents are already stored in the browser cache. In determination block 612, the mobile device may determine whether the generated signature is already represented in the signature data table. This may be accomplished by the mobile device determining whether the generated signature matches a signature entry in the signature data table. If the generated signature is already represented in the signature data table (i.e., determination block 612=“Yes”), in block 613 the mobile device may use the downloaded or the corresponding cached resource to generate the webpage. The resource may already be stored in the browser cache and may be linked to a signature entry in the signature data table. Alternatively, the resource may be in a download buffer or other storage area based on the operations in block 606. The mobile device may not add a new signature entry to the signature data table. For example, the mobile device may utilize the resource in the browser cache linked to the matching signature entry to render the webpage.

However, if the generated signature is not already represented (i.e., determination block 612=“No”), in block 614, if needed, the mobile device may evict a previously cached resource that is unrelated to the generated signature. In an aspect, such a previously cached resource may be evicted based on a cache eviction policy implemented by the mobile device. The cache eviction policy may indicate when and what resources may be evicted (or removed) from cache. For example, executing eviction policy routines, the mobile device may determine that a resource may be evicted from browser cache when the cache is full and the downloaded resource needs to be cached. Performing cache eviction (or cache management) routines, the mobile device may detect resources stored in cache that are unrelated to the downloaded resource based on corresponding signature entries within the signature data table, such as URL/URI information stored in association with the various resources in cache. For example, the mobile device may not evict a resource from cache that has a URI that is similar to the URI of the downloaded resource (e.g., both relate to items within the same webpage). In various aspects, cache management routines may set bits associated with cache locations that indicate whether the resources stored within the locations may be cleared, overwritten, or ejected. In an aspect, if the cache is not full, the mobile device may not evict any resource based on a cache eviction policy. In block 615, if needed, the mobile device may remove the signature related to any evicted resource from the signature data table. In other words, in response to evicting a resource from the browser cache, the mobile device may remove from the signature data table the signature entry linked to the evicted resource. For example, the data table entry corresponding to a resource evicted from the browser cache may be cleared so that only resources currently stored in the cache may be represented in the signature data table with corresponding signature entries.

In block 616, the mobile device may use the downloaded resource, such as for generating the webpage. In block 617, the mobile device may store the downloaded resource in a cache memory location, such as a memory location associated with the browser cache. In various aspects, the mobile device may also perform cache eviction operations when storing the downloaded resource in the browser cache. In block 618, the mobile device may add a signature entry for the generated signature to the signature data table with a connection to the cache memory location. In other words, the mobile device may create a signature entry in the signature data table that represents the generated signature. For example, the signature entry may correspond to the generated signature and may link to the cached resource (i.e., include a reference to the browser cache memory location in which the downloaded resource contents are stored). After the mobile device performs the operations in block 618 or block 613, in block 620 the mobile device may update the signature data table to show the connection between the URI and the signature entry, such as by updating the signature entry corresponding to the generated signature to reference the URI of the resource. In other words, the URI of the resource may be related to the generated signature and likewise the browser cache location of the stored resource.

In determination block 622, the mobile device may determine whether there are more resources associated with the webpage to be addressed. In other words, the mobile device may determine whether all resources indicated by URIs in the received instructions from the web server have been addressed (e.g., downloaded, found in browser cache, etc.). If there are more resources (i.e., determination block 622=“Yes”), the mobile device may continue with the operations in block 606. If there are no more resources to be addressed, such as no more resources to download or find stored in browser cache (i.e., determination block 622=“No”), in block 624 the mobile device may render the webpage with downloaded or previously cached resources. In particular, the browser may use resources obtained from the browser cache (i.e., whose generated signatures were matched with entries pre-existing in the signature table) and resources downloaded (i.e., whose generated signatures were not matched). For example, the browser may render an image resource of the webpage by generating a signature related to the URI of the resource, matching the generated signature to an entry in the signature data table, determining the browser cache location related to the matched signature entry in the signature data table, and retrieving the image resource from the determined browser cache location.

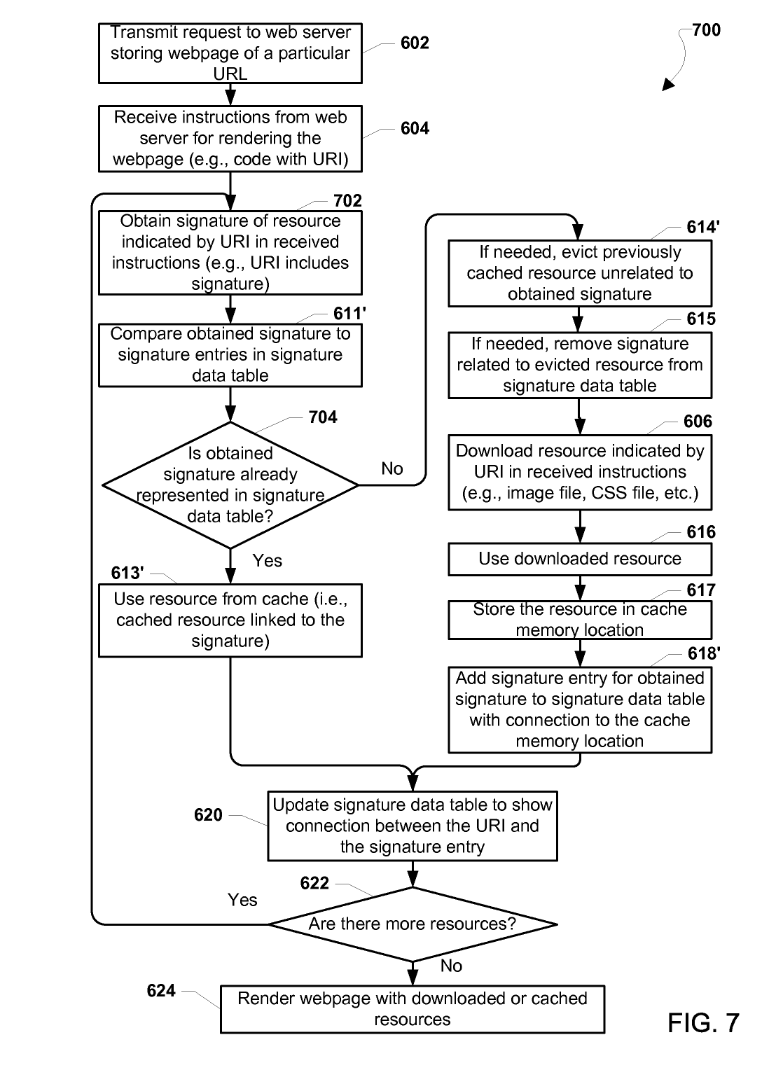

FIG. 7 illustrates an aspect method 700 for a mobile device using signatures received from a third-party to avoid storing redundant copies of a resource for a webpage in a browser cache. In various aspects, algorithms, operations, and/or routines for generating signatures characterizing webpage resources may be performed by the mobile device (as described above with reference to FIG. 6) or, alternatively, by a third-party computing device, a web server, a third-party service, a proxy server, etc. When signature generation operations are performed by a third-party computing device, a web server, a third-party service, etc., the algorithms, operations, and/or routines used to generate the signature may be standardized. For example, the algorithm used to generate a signature for a particular webpage resource may be the same when employed by the mobile device or a web server.

Accordingly, the method 700 is similar to the method 600, except that the mobile device may receive a signature related to a resource from another computing device, such as the web server hosting the webpage, and compare the received signature to the mobile device's signature data table to determine whether the signature matches a signature of a resource present in the browser cache. Thus, the mobile device may only download the resource when the received signature is not in the mobile device's signature data table.

In block 602, the mobile device may transmit a request to a web server storing a webpage of a particular URL, such as a message requesting delivery of the webpage. In block 604, the mobile device may receive instructions from the web server for rendering the webpage, such as code that indicates the various URI or resources associated with the webpage. In particular, the instructions may include signatures for each of the resources referenced. For example, the HTML code for the webpage may include signature information in a header, or alternatively, the URI information in the HTML code may have an appended signature. As described above, the signature may be generated by the web server (or another third-party computing device) using standardized algorithms and/or operations, such as a hash operation.

In block 702, the mobile device may obtain a signature of a resource indicated by a URI in the received instructions. For example, the mobile device may obtain the signature from the HTML code of the webpage by parsing the URI of the resource (e.g., the signature may be indicated in-line with the URI). Alternatively, the mobile device may obtain the signature from another server, such as part of a service to facilitate mobile web browsing. For example, the mobile device may contact a third-party server that transmits manifests enumerating the resources related to the webpage and including the signatures of the resources.

In block 611′, the mobile device may compare the obtained signature to signature entries in a signature data table maintained by the mobile device. In determination block 704, the mobile device may determine whether the obtained signature is already represented in a signature data table maintained by the mobile device. In other words, the mobile device may determine whether the obtained signature matches a signature entry in the signature data table. If the obtained signature is not already represented in the signature data table (i.e., determination block 704=“No”), in block 614′, if needed, the mobile device may evict a previously cached resource that is unrelated to the obtained signature. For example, the mobile device may evict a previously cached resource based on a cache eviction policy as described above. In block 615, if needed, the mobile device may remove from the signature data table the signature related to any evicted resource. In block 606, the mobile device may download the resource indicated by the URI in the received instructions from the web server, such as an image, video, text or CSS file. In block 616, the mobile device may use the downloaded resource for generating the webpage. In block 617, the mobile device may store the downloaded resource in a cache memory location, such as a memory location associated with the browser cache. In block 618′, the mobile device may add a signature entry for the obtained signature to the signature data table with a connection to the cache memory location. In other words, the mobile device may create a signature entry in the signature data table that represents the obtained signature. For example, the signature entry may correspond to the obtained signature and may link to the cached resource (i.e., the signature entry may include a reference to the browser cache location in which the resource is stored). If the obtained signature is already represented in the signature data table (i.e., determination block 704=“Yes”), in block 613′ the mobile device may obtain and use the corresponding resource from the cache to generate the webpage. The resource may already be stored in the browser cache and may be linked to a signature entry in the signature data table.

After or as part of the mobile device performing the operations in block 618′ or block 613′, the mobile device may update the signature data table to show the connection between the URI and the signature entry in block 620. For example, the signature entry corresponding to the obtained signature may be modified to reference the URI of the resource. In determination block 622, the mobile device may determine whether there are more resources associated with the webpage to be addressed. For example, the mobile device may determine whether there are any more resources to evaluate to determine whether the resources need to be downloaded to render the webpage. If there are more resources to be addressed (i.e., determination block 622=“Yes”), the mobile device may continue with the operations in block 702. If there are no more resources to be addressed (i.e., determination block 622=“No”), in block 624 the mobile device may render the webpage with downloaded or previously cached resources. For example, the mobile device may render the webpage with the browser application by retrieving the webpage's resources from the browser cache based on relationships stored in the signature data table.

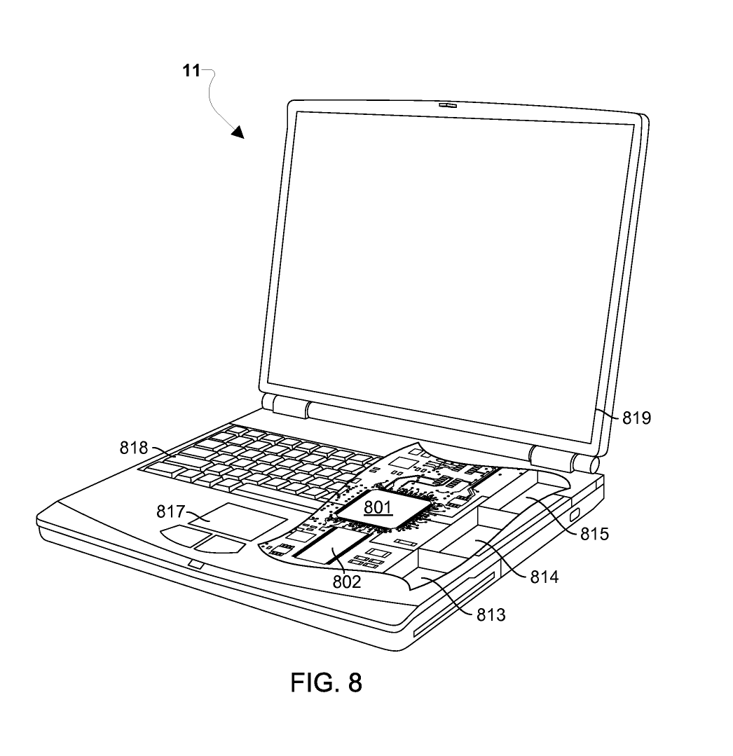

The aspects described above may also be implemented within a variety of personal computing mobile devices, such as a laptop computer mobile device 11 as illustrated in FIG. 8. Many laptop computer mobile devices 11 include a touch pad touch surface 817 that serves as the computer's pointing device, and thus may receive drag, scroll, and flick gestures similar to those implemented on mobile computing devices equipped with a touch screen display and described above. A laptop computer mobile device 11 may typically include a processor 801 coupled to volatile memory 802 and a large capacity nonvolatile memory, such as a disk drive 813 of Flash memory. The laptop computer mobile device 11 may also include a floppy disc drive 814 and a compact disc (CD) drive 815 coupled to the processor 801. The laptop computer mobile device 11 may also include a number of connector ports coupled to the processor 801 for establishing data connections or receiving external memory devices, such as a USB or FireWire® connector sockets, or other network connection circuits for coupling the processor 801 to a network. In a notebook configuration, the computer housing includes the touch pad touch surface 817, the keyboard 818, and the display 819 all coupled to the processor 801. Other configurations of computing device may include a computer mouse or trackball coupled to the processor (e.g., via a USB input) as are well known, which may also be use in conjunction with the various aspects.

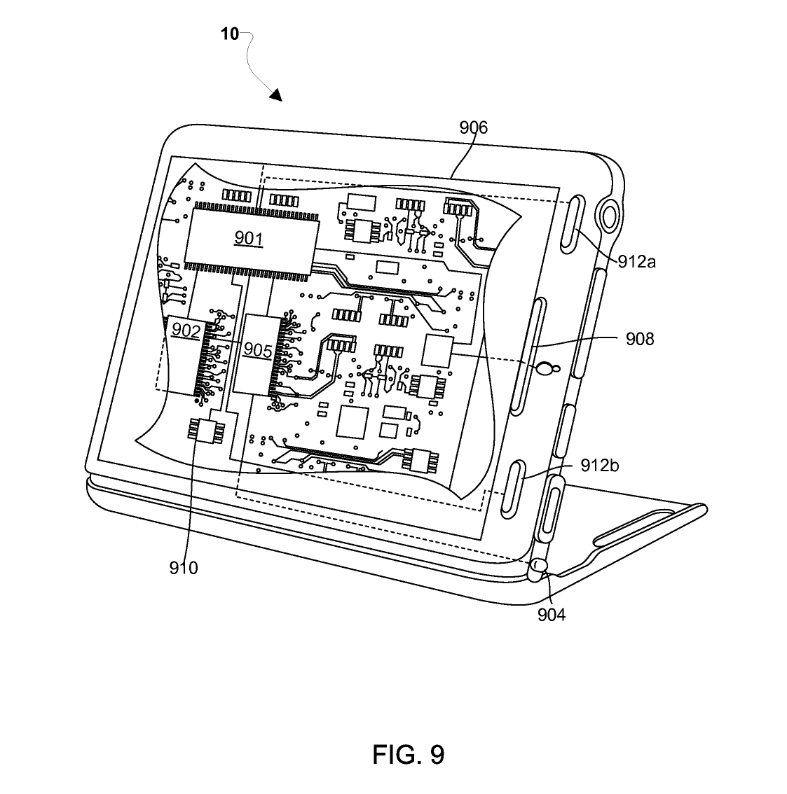

FIG. 9 is a system block diagram of a mobile device 10 suitable for use with any of the aspects. A typical mobile device 10 may include a processor 901 coupled to internal memory 902, a display 906, and to a speaker 908. Additionally, the mobile device may include an antenna 904 for sending and receiving electromagnetic radiation that may be connected to a wireless data link and/or cellular telephone transceiver 905 coupled to the processor 901 and a mobile multimedia broadcast receiver 910 coupled to the processor. Mobile devices 10 typically also include menu selection buttons 912a, 912b (or rocker switches) for receiving user inputs.

The processors 901 and 801 may be any programmable microprocessor, microcomputer or multiple processor chip or chips that can be configured by software instructions (applications) to perform a variety of functions, including the functions of the various aspects described above. In some devices, multiple processors 901 and 801 may be provided, such as one processor dedicated to wireless communication functions and one processor dedicated to running other applications. Typically, software applications may be stored in the internal memory 902 and 802 before they are accessed and loaded into the processor 901 and 801. The processor 901 and 801 may include internal memory sufficient to store the application software instructions. In many devices the internal memory may be a volatile or nonvolatile memory, such as flash memory, or a mixture of both. For the purposes of this description, a general reference to memory refers to memory accessible by the processor 901 and 801 including internal memory or removable memory plugged into the device and memory within the processor 901 and 801 itself.

The foregoing method descriptions and the process flow diagrams are provided merely as illustrative examples and are not intended to require or imply that the steps of the various aspects must be performed in the order presented. As will be appreciated by one of skill in the art the order of steps in the foregoing aspects may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module, which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A method for avoiding storage of redundant webpage content in a browser cache, comprising:
comparing a first signature based on contents of a first resource referenced by a webpage to a group of signatures related to resources stored in the browser cache;
using a second resource stored in the browser cache to generate the webpage when the first signature matches one of the group of signatures but not storing the first resource in the browser cache; and
storing the first resource in the browser cache linked to the first signature and adding the first signature to the group of signatures when the first signature does not match any signature within the group of signatures.

2. The method of claim 1, further comprising:
evicting a third resource stored in the browser cache when the first signature does not match any signature within the group of signatures based on a cache eviction policy; and
removing a third signature corresponding to the third resource from the group of signatures in response to evicting the third resource.

3. The method of claim 1, wherein the first resource is associated with a universal resource identifier.

4. The method of claim 1, wherein comparing a first signature based on contents of a first resource referenced by a webpage to a group of signatures related to resources stored in the browser cache comprises:
downloading the first resource based on instructions for rendering the webpage;
generating the first signature based on contents of the first resource; and
comparing the generated first signature to the group of signatures related to resources currently stored within the browser cache.

5. The method of claim 1, wherein the first resource is a file of a cacheable content type.

6. The method of claim 5, wherein the first resource is at least one of a style sheet, a framework, an application programming interface, a library file, a video, an image, a photo, a text file, a Flash file, a Shockwave file, an applet, software instructions, a script, and a theme.

7. The method of claim 1, wherein comparing a first signature based on contents of a first resource referenced by a webpage to a group of signatures related to resources stored in the browser cache comprises:
obtaining the first signature for the first resource when initially downloading the webpage;
comparing the obtained first signature to the group of signatures related to resources stored in the browser cache;
using the second resource stored in the browser cache to generate the webpage when the obtained first signature matches one of the group of signatures related to resources stored in the browser cache;
downloading the first resource; and
using the downloaded first resource to generate the webpage when the obtained first signature does not match any of the group of signatures related to resources stored in the browser cache.

8. The method of claim 7, wherein the obtained first signature is obtained from one of a third-party service, a proxy server, and a web server hosting the webpage.

9. The method of claim 7, wherein the obtained first signature is generated by one of a third-party service, a proxy server, and a web server hosting the webpage.

10. A mobile device, comprising:
means for comparing a first signature based on contents of a first resource referenced by a webpage to a group of signatures related to resources stored in a browser cache;
means for using a second resource stored in the browser cache to generate the webpage when the first signature matches one of the group of signatures but not storing the first resource in the browser cache; and
means for storing the first resource in the browser cache linked to the first signature and adding the first signature to the group of signatures when the first signature does not match any signature within the group of signatures.

11. The mobile device of claim 10, further comprising:
means for evicting a third resource stored in the browser cache when the first signature does not match any signature within the group of signatures based on a cache eviction policy; and
means for removing a third signature corresponding to the third resource from the group of signatures in response to evicting the third resource.

12. The mobile device of claim 10, wherein the first resource is associated with a universal resource identifier.

13. The mobile device of claim 10, wherein means for comparing a first signature based on contents of a first resource referenced by a webpage to a group of signatures related to resources stored in the browser cache comprises:
means for downloading the first resource based on instructions for rendering the webpage;
means for generating the first signature based on contents of the first resource; and
means for comparing the generated first signature to the group of signatures related to resources currently stored within the browser cache.

14. The mobile device of claim 10, wherein the first resource is a file of a cacheable content type.

15. The mobile device of claim 14, wherein the first resource is at least one of a style sheet, a framework, an application programming interface, a library file, a video, an image, a photo, a text file, a Flash file, a Shockwave file, an applet, software instructions, a script, and a theme.

16. The mobile device of claim 10, wherein means for comparing a first signature based on contents of a first resource referenced by a webpage to a group of signatures related to resources stored in the browser cache comprises:
means for obtaining the first signature for the first resource when initially downloading the webpage;
means for comparing the obtained first signature to the group of signatures related to resources stored in the browser cache;
means for using the second resource stored in the browser cache to generate the webpage when the obtained first signature matches one of the group of signatures related to resources stored in the browser cache;
means for downloading the first resource; and
means for using the downloaded first resource to generate the webpage when the obtained first signature does not match any of the group of signatures related to resources stored in the browser cache.

17. The mobile device of claim 16, wherein the obtained first signature is obtained from one of a third-party service, a proxy server, and a web server hosting the webpage.

18. The mobile device of claim 16, wherein the obtained first signature is generated by one of a third-party service, a proxy server, and a web server hosting the webpage.

19. A mobile device, comprising:
a memory;
a transceiver configured to communicate with a network; and
a processor coupled to the memory and the transceiver, wherein the processor is configured with processor-executable instructions to perform operations comprising:
comparing a first signature based on contents of a first resource referenced by a webpage to a group of signatures related to resources stored in a browser cache;
using a second resource stored in the browser cache to generate the webpage when the first signature matches one of the group of signatures but not storing the first resource in the browser cache; and
storing the first resource in the browser cache linked to the first signature and adding the first signature to the group of signatures when the first signature does not match any signature within the group of signatures.

20. The mobile device of claim 19, wherein the processor is configured with processor-executable instructions to perform operations further comprising:
evicting a third resource stored in the browser cache when the first signature does not match any signature within the group of signatures based on a cache eviction policy; and
removing a third signature corresponding to the third resource from the group of signatures in response to evicting the third resource.

21. The mobile device of claim 19, wherein the processor is configured with processor-executable instructions to perform operations such that the first resource is associated with a universal resource identifier.

22. The mobile device of claim 19, wherein the processor is configured with processor-executable instructions to perform operations such that comparing a first signature based on contents of a first resource referenced by a webpage to a group of signatures related to resources stored in the browser cache comprises:
downloading the first resource based on instructions for rendering the webpage;
generating the first signature based on contents of the first resource; and
comparing the generated first signature to the group of signatures related to resources currently stored within the browser cache.

23. The mobile device of claim 19, wherein the processor is configured with processor-executable instructions to perform operations such that the first resource is a file of a cacheable content type.

24. The mobile device of claim 23, wherein the processor is configured with processor-executable instructions to perform operations such that the first resource is at least one of a style sheet, a framework, an application programming interface, a library file, a video, an image, a photo, a text file, a Flash file, a Shockwave file, an applet, software instructions, a script, and a theme.

25. The mobile device of claim 19, wherein the processor is configured with processor-executable instructions to perform operations such that comparing a first signature based on contents of a first resource referenced by a webpage to a group of signatures related to resources stored in the browser cache comprises:
obtaining the first signature for the first resource when initially downloading the webpage;
comparing the obtained first signature to the group of signatures related to resources stored in the browser cache;
using the second resource stored in the browser cache to generate the webpage when the obtained first signature matches one of the group of signatures related to resources stored in the browser cache;
downloading the first resource; and
using the downloaded first resource to generate the webpage when the obtained first signature does not match any of the group of signatures related to resources stored in the browser cache.

26. The mobile device of claim 25, wherein the processor is configured with processor-executable instructions to perform operations such that the obtained first signature is obtained from one of a third-party service, a proxy server, and a web server hosting the webpage.

27. The mobile device of claim 25, wherein the processor is configured with processor-executable instructions to perform operations such that the obtained first signature is generated by one of a third-party service, a proxy server, and a web server hosting the webpage.

28. A non-transitory processor-readable storage medium having stored thereon processor-executable instructions configured to cause a processor to perform operations comprising:
comparing a first signature based on contents of a first resource referenced by a webpage to a group of signatures related to resources stored in a browser cache;
using a second resource stored in the browser cache to generate the webpage when the first signature matches one of the group of signatures but not storing the first resource in the browser cache; and
storing the first resource in the browser cache linked to the first signature and adding the first signature to the group of signatures when the first signature does not match any signature within the group of signatures.

29. The non-transitory processor-readable storage medium of claim 28, wherein the stored processor-executable instructions are configured to cause the processor to perform operations further comprising:
evicting a third resource stored in the browser cache when the first signature does not match any signature within the group of signatures based on a cache eviction policy; and
removing a third signature corresponding to the third resource from the group of signatures in response to evicting the third resource.

30. The non-transitory processor-readable storage medium of claim 28, wherein the stored processor-executable instructions are configured to cause the processor to perform operations such that the first resource is associated with a universal resource identifier.

31. The non-transitory processor-readable storage medium of claim 28, wherein the stored processor-executable instructions are configured to cause the processor to perform operations such that comparing a first signature based on contents of a first resource referenced by a webpage to a group of signatures related to resources stored in the browser cache comprises:
downloading the first resource based on instructions for rendering the webpage;
generating the first signature based on contents of the first resource; and
comparing the generated first signature to the group of signatures related to resources currently stored within the browser cache.

32. The non-transitory processor-readable storage medium of claim 28, wherein the stored processor-executable instructions are configured to cause the processor to perform operations such that the first resource is a file of a cacheable content type.

33. The non-transitory processor-readable storage medium of claim 32, wherein the stored processor-executable instructions are configured to cause the processor to perform operations such that the first resource is at least one of a style sheet, a framework, an application programming interface, a library file, a video, an image, a photo, a Flash file, a Shockwave file, an applet, software instructions, a script, and a theme.

34. The non-transitory processor-readable storage medium of claim 28, wherein the stored processor-executable instructions are configured to cause the processor to perform operations such that comparing a first signature based on contents of a first resource referenced by a webpage to a group of signatures related to resources stored in the browser cache comprises:
obtaining the first signature for the first resource when initially downloading the webpage;
comparing the obtained first signature to the group of signatures related to resources stored in the browser cache;
using the second resource stored in the browser cache to generate the webpage when the obtained first signature matches one of the group of signatures related to resources stored in the browser cache;
downloading the first resource; and
using the downloaded first resource to generate the webpage when the obtained first signature does not match any of the group of signatures related to resources stored in the browser cache.

35. The non-transitory processor-readable storage medium of claim 34, wherein the stored processor-executable instructions are configured to cause the processor to perform operations such that the obtained first signature is obtained from one of a third-party service, a proxy server, and a web server hosting the webpage.

36. The non-transitory processor-readable storage medium of claim 34, wherein the stored processor-executable instructions are configured to cause the processor to perform operations such that the obtained first signature is generated by one of a third-party service, a proxy server, and a web server hosting the webpage.

37. A system, comprising:
a server; and
a mobile device,
wherein the server is configured with server-executable instructions to perform operations comprising:
generating a first signature based on contents of a first resource associated with a webpage;
receiving a request corresponding to the webpage from the mobile device; and
transmitting instructions for rendering the webpage to the mobile device in response to receiving the request, wherein the instructions include the first signature, and
wherein the mobile device comprises:
a memory;
a transceiver configured to communicate with a network coupled to the server; and
a processor coupled to the memory and the transceiver, and configured with processor-executable instructions to perform operations comprising:
transmitting the request corresponding to the webpage to the server;
receiving instructions for rendering the webpage from the server;
obtaining the first signature from the received instructions;
comparing the first signature to a group of signatures related to resources stored in a browser cache of the mobile device;
using a second resource stored in the browser cache to generate the webpage when the first signature matches one of the group of signatures but not storing the first resource in the browser cache; and
storing the first resource in the browser cache linked to the first signature and adding the first signature to the group of signatures when the first signature does not match any signature within the group of signatures.

38. The system of claim 37, wherein the server is one of a third-party service server, a proxy server, and a web server hosting the webpage.
